(19) United States
(12) Patent Application Publication
(10) Pub. No.: US 2014/0280378 A1
(43) Pub. Date: Sep. 18, 2014

(54) DATABASE GENERATOR

(71) Applicant: Adminovate, Inc., Philadelphia, PA (US)

(72) Inventors: Duane Pressley, Philadelphia, PA (US); Christopher Gali, Philadelphia, PA (US); Christopher Doggett, Philadelphia, PA (US)

(73) Assignee: Adminovate, Inc., Philadelphia, PA (US)

(21) Appl. No.: 14/211,871

(22) Filed: Mar. 14, 2014

Related U.S. Application Data
(60) Provisional application No. 61/784,357, filed on Mar. 14, 2013.

(51) Int. Cl. G06F 17/30

(52) U.S. Cl. CPC G06F 17/30289
USPC 707/805

(57) ABSTRACT

A database file generation system receives, from a user via a user interface, a set of entities and at least one attribute that is associated with each entity. The system will generate one or more database files in an intermediate language. The database files may include one or more relationships for each entity, one or more rules that define how a result will be sent to a database in response to a query, and one or more rules that define how a result will be retrieved from a database in response to a query. The system will then apply the database files to a database library to generate a database comprising the entities, the relationships and the rules.

### RELATED APPLICATIONS AND CLAIM OF PRIORITY

This patent application claims priority to U.S. Provisional Patent Application No. 61/784,357, filed Mar. 14, 2013, the disclosure of which is fully incorporated herein by reference.

### BACKGROUND

The creation of databases is a labor-intensive process. Many hours of coding may be required for even a routine software application. In addition, the results of manual database creation can be inconsistent, especially when developed for use in connection with a software application. While some software developers may produce efficient code, others may unnecessarily create complex code files that are difficult to debug or modify.

This document describes methods and systems that address some of the problems listed above, and/or other issues.

### SUMMARY

In an embodiment, in an automated method of generating a database file, a file generation system may generate a user interface for receiving database information. The system will receive, from a user via the user interface, a set of entities and at least one attribute that is associated with each entity. The system will generate one or more database files in an intermediate language. The database files may include one or more relationships for each entity, one or more rules that define how a result will be sent to a database in response to a query, and one or more rules that define how a result will be retrieved from a database in response to a query. The system will then apply the database files to a database library to generate a database comprising the entities, the relationships and the rules. Optionally, generating the database may also comprise including, in the database application, a plurality of predefined code portions that do not define any of the entities.

Optionally, each of the relationships in each entity's database file may include at least one of the following: an attribute that is associated with the entity; or another entity with which the entity is associated. For each entity, when receiving the entity and generating the associated entity file, the system may receive a name for the entity; receive a type for each received attribute for the entity; and save the name, attributes and types in the entity file according to a intermediate language entity file structure.

In some embodiments, the system may also generate one or more entity files in the intermediate language, wherein each entity file contains attributes for one or more of the selected entities so that each selected entity and its attributes are represented in the entity files. If so, the system may receive a process model via the user interface, and it may generate a process file in the intermediate language for the process model.

For each database file whose entity is associated with another entity, the system may also identify the other entity; determine a relationship identifier; and save a name of the entity, a name of the other entity, and the relationship identifier in the database file according to a pre-defined intermediate language process file structure.

In some embodiments, the system may presenting the user interface to a user so that the user interface comprises an entity definition module, and a process modeling module comprising a plurality of graphic representations of actions and a layout. If so, when receiving the process model, the system may receive a graphic representation of the process model in a flow diagram format.

### BRIEF DESCRIPTION OF THE DRAWINGS

FIG. 1 illustrates an example of a user interface for a code generation system.

FIG. 2 is a flow diagram illustrating various steps that a code generation process may implement.

FIG. 3 is a block diagram of hardware that may be used to contain or implement program instructions according to an embodiment.

### DETAILED DESCRIPTION

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include the plural reference unless the context clearly dictates otherwise. Unless defined otherwise, all technical and scientific terms used herein have the same meanings as commonly understood by one of ordinary skill in the art. Nothing in this document is to be construed as an admission that the embodiments described in this document are not entitled to antedate such disclosure by virtue of prior invention. As used in this document, the term “comprising” means “including, but not limited to.”

For purposes of this document, a “computing device” or an “electronic device” refers to a device that includes a processor and non-transitory, computer-readable memory. The memory may contain programming instructions that, when executed by the processor, cause the computing device to perform one or more operations according to the programming instructions. Examples of computing devices include personal computers, servers, mainframes, gaming systems, televisions, and portable electronic devices such as smartphones, personal digital assistants, cameras, tablet computers, laptop computers, media players and the like.

In the discussion below, a software and database development system allows a user to build a software application and/or database by defining entities, attributes and processes. These terms are each intended to have their common meaning in software development. For example, an entity may be an object on which the program acts or which the database stores. Examples of entities may include a contact, an insurance policy, a financial institution, or another item that plays a role in the system and which may be defined by one or more attributes. Processes are actions that may be performed on one or more entities. Attributes are variables that may be used to describe one or more properties of an entity or process.

The system described in this document generates an intermediate programming language, which is then used to generate the final software code and/or database in a programming language or interpreted language that differs from the intermediate programming language. (This document will generally use the term “programming language” to refer to either a programming language or interpreted language unless the context indicates otherwise.) Unlike prior automated software and database generation systems, the systems described in this document do not need to rely on templates to generate the final products. The system allows a user who has little or no software programming experience to define the code's requirements via a graphical user interface, such as one that allows the user to create a process flow diagram by dragging and dropping various icons onto a drawing page field. The user may use the user interface to describe a process model. After the user defines the code's requirements in the process model, the system automatically generates various files in the intermediate programming language to implement the process model. Optionally, the user may have an opportunity to review various aspects of the program. The system then automatically converts the intermediate language files into a software application or database of a programming language other than the intermediate language, such as C#, C++, Java and other now or hereafter known programming languages.

FIG. 1 illustrates an example of a graphical user interface 100 that the system may provide for receiving software application information. For the purpose of illustration, this discussion will describe an example software application that enables the user to create a contact management software application and a contacts database. In FIG. 1, the interface includes an entity definition module, which is a portion of the interface that allows the user to define one or more entities 101 and one or more processes 105 by providing drawing page fields for each such item. The example entities 101 shown in FIG. 1 are PersonContact and CompanyContact. As shown, each entity is presented on a unique page on which the user may define the entity by assigning attributes and/or relationships to the entity, but other configurations are possible. Optionally, the system may include one or more pre-defined entities that the user may choose to select and add to the software application or database. Pre-defined entities may have pre-assigned attributes, which the user may be permitted to modify in some embodiments. The system also may allow the user to define entities anew by assigning them a name, one or more attributes, and optionally one or more relationship to other entities. For example, the entity PersonContact may be defined to allow a user to assign a relationship between any PersonContact and any CompanyContact, such as to indicate that the person works for or is otherwise affiliated with a company.

FIG. 1 also shows a process modeling module, such as a drawing page field for defining a process model for a process 103. The user interface may include a set of action icons 107 that the user may drag and drop onto the drawing page to define the process model as a flow diagram 109. Action icons 107 may include pre-defined actions such as start process, update a value, retrieve data from a database, execute, call another process or any number of additional actions. The user may be permitted to modify attributes of pre-defined actions, and the user may be permitted to define some actions anew. The process model interface also may include a configuration field in which the user may enter free-form text or select from pre-defined items to configure the process, such as by assigning the process a name and one or more categories 115. The configuration field also may permit the user to select one or more entities and/or entity attributes that will serve as inputs and/or outputs 117 for the process.

When the user defines an entity or process via the user interface, the system may generate code files in an intermediate programming language for one or more of the entities and/or processes. Each intermediate language file will follow a dialect and format that the system may then use to convert the intermediate code files to the end-result programming language.

For example, an entity file in the intermediate language may include lines for the entity name, user-defined attributes, system pre-defined attributes, relationships, behaviors, and/or other characteristics. As an example of an intermediate language file for a CompanyContact entity and its related PersonContacts, the intermediate language file may follow a structure such as:

Entity PatentDemo.CompanyContact

| | |
|---|---|
| Text | Name |
| Text | Adddress |

ChildEntityList<PatentDemo.PersonContact> PersonContacts

| | |
|---|---|
| Text | FirstName |
| Text | LastName |
| Text | PhoneNumber |

EndChildEntityList
EndEntity

As another example, a process file in the intermediate language may include code lines for input entities and/or attributes, other processes that the process calls, actions taken and/or outputs generated. As an example, an intermediate language file for a PersonContact save process may include code lines such as:

```
Process PatentDemo.SavePersonContact
  Uses PatentDemo.PersonContact
  Outputs.NewPersonContact = PersonContact {
    FirstName = Inputs.FirstName
    LastName = Inputs.LastName
    PhoneNumber = Inputs.PhoneNumber
  }
EndProcess
ProcessInputs
  Text FirstName
  Text LastName
  Text PhoneNumber
EndProcessInputs
ProcessOutputs
  PersonContact NewPersonContact
EndProcessOutputs
```

Thus, as described above, the system may generate a set of one or more entity intermediate language files and one or more process intermediate language files, each of which uses grammar structures that are established by an entity file rule set and/or a process file rule set.

FIG. 2 is a block diagram illustrating various steps that a system for generating code may implement. Using an electronic device, the system may present a user with a user interface 201 for defining entities and a process model. The system may generate the user interface using programming instructions that are stored in a memory of the electronic device. Alternatively, the programming instructions may be housed on and at least partially executed by one or more remote processor and memory devices, such as in a cloud-based system where the user interface appears on the user's device via a browser or mobile device app.

By way of an entity definition module of the user interface, the system will receive entity and attribute definitions 203 via the user interface as described above. For example, for each entity the system may receive an entity name, one or more attributes, and a type for any or all of the attributes. The entity definition module displays or otherwise presents the user with input fields for any or all of these variables in a form that allows free-form text entry (such as via a keyboard, keypad, or speech-to-text conversion software), and/or which includes certain values that the user may select.

By way of a process modeling module of the user interface, the system will receive the process model 205 as described above. For example, the process model may identify input entities and/or attributes, other processes that the process calls, actions taken and/or outputs generated. As with the entity definition module, the process modeling module may display or otherwise present the user with input fields for any or all of these variables in a form that allows free-form text entry (such as via a keyboard, keypad, or speech-to-text conversion software), and/or which includes certain values that the user may select. In some embodiments, the process modeling module may include various icons that provide graphic representations of various actions, and a layout page on which the user may assemble the icons into a process model as a flow diagram.

The system will generate one or more intermediate language files for the received entities and processes 207. The intermediate language files will be generated in accordance with a pre-defined file structure and saved to memory. The intermediate language files may include entity files, each of which defines one or more of the selected entities. The intermediate language files also may include one or more process files that define the process model in accordance with the user's definitions. Some or all of the intermediate language files may include the characteristics selected by the user, as well as pre-defined characteristics and/or actions that are required by the system. For example, if a user selects a “retrieve data set” action, the system may implement a rule that requires the process to include other actions that are related to the “retrieve data set” action, such as sorting and/or filtering the data set before displaying it to the user.

When generating a file for a process model in the intermediate language, the system may create a content object for the process model, assign a name to the process based on the user's selection, identify at least one input and at least one output for the process, and identify one or more actions for the process based on user selections and/or system rules. The system may save each of these items to the process file according to a pre-defined intermediate language process file structure.

Optionally, the system also may generate one or more view intermediate language files 209 that define one or more features of a data input page for the software application. This may happen if the user has supplied, via the user interface, one or more attributes for the data input page. The view intermediate language files may contain (in the intermediate language) a set of rules that define the layout, functions and attributes of the data input page. A view intermediate language file may be useful in cases such as a web application, where the user desires to generate a web page or other interface that is then presented to users via a browser.

The system will then convert the intermediate language files into the final programming language 215, such as C#, C++ or Java. Prior to or as part of this process, the system may parse 211 each intermediate language file to identify one or more code segments having recognized grammar structures. A grammar structure will be recognized if it follows a format that matches a recognized format, as determined by a comparing process or a rule set. For example, a rule set may indicate that if a code line starts with the word “Entity,” then the system should determine that the code that follows will contain attributes and/or relationships for that entity until the system encounters a stop command (such as “EndEntity”) in the code. The system may include various conversion rules that are associated with various grammar structures. The system may apply the conversion rules so that when the system identifies a code segment having a recognized grammar structure, it applies the grammar structure's associated rule and converts that segment of the intermediate language code to a segment of the final code. The system will repeat this process for all segments of the intermediate language code until all intermediate language segments are converted to the final programming language code.

Optionally, the system may include one or more predefined functional code portions in the converted (final programming language) application 213. For example, a “save entity to database” process may be available for any process that allows a user to create new entities, such as contact management or legal agreement management software.

Any or all of the steps described above may be implemented automatically, such as after the occurrence of certain events (such as completion of an entity definition). Alternatively, the user interface may include one or more command functions through which a user may issue a command to build an intermediate language file, or to develop the final code based on the intermediate language files. Optionally, the system may also have a function that compiles the final programming language file or files into executable code 217. Any now or hereafter known compiler may be used for this final step.

In some embodiments, in addition to (or instead of) creating the software application, the system may create a database that includes each of the entities that the user has defined. For example, after the system receives entity definitions, it may generate a database mapping file for each received entity 253. Each mapping file may include one or more relationships for its associated entity, the relationship being an attribute of the entity and/or the identity of another entity with which the mapping file's entity is associated (such as in a parent-child relationship). The system also may generate one or more repository files 255 that contain one or more rules that define how a result will be entered in or output from the database. As an example rules for a repository file in a financial database may be embodied in code such as:

```
Outputs/ConstantMaturityTreasuryRates = Data.LookupArray {
    DataGroup IsEqualTo “ConstantMaturityTreasuryRates”
    EffectiveDate IsGreaterThanOrEqualTo Inputs.StartDate
    EffectiveDate IsLessThanOrEqualTo Inputs.EndDate
    OrderBy {
    EffectiveDate, Direction.descending
}
```

In this way, the generated mapping/repository files may include one or more relationships for each entity, one or more rules that describe how a result will be sent to the database in response to an input query, and one or more rules that describe how a result will be retrieved from the database in response to a request query. The intermediate language and/or final language database also may include one or more pre-defined code portions that do not define any entities. For example, pre-defined code portions may include rules that are common to various types of software, such as common layout rules, rules for input/output of any data type, and other pre-defined code portions.

A process model may not be required if the intent is to create only a database, and not the software application.

The systems described above may be used to create various types of software applications. For example, the system may create a contacts management software application and/or contacts database as described above by providing a set of potential entities (categories of contacts) and attributes (such as name, phone number, email address, etc.) that the user may select, supplement and/or modify. Other applications include the development of insurance claims processing software.

For example, a set of entities for insurance policy administration software may include an AccountRemoval entity, which describes the removal of money from a financial account, and a Policy entity, which describes the contract purchased by an insured. In such a situation, an example entity definition for the AccountRemoval entity may include the attributes such as those shown in the following text:

| Entity AccountRemoval | |
|---|---|
| Sequence | Sequence |
| Date | EffectiveDate |
| Currency | RemovedAccountValue |
| Currency | RemovedPrincipal |
| EndEntity | |

Similarly, an example entity definition for the AccountRemoval entity may include attributes such as those shown in the following text:

| | |
|---|---|
| Entity Policy | |
| Text | PolicyNumber |
| Date? | IssueDate |
| Date | ApplicationSignedDate |
| PolicyStatus | Status |
| State | IssueState |
| Date? | MaturityDate |
| Date? | FreeLookEndDate |
| Date? | RateLockDate |
| Integer? | PolicyYear |
| Date? | ValuationDate |
| Text? | IssueBlockDescription |
| Text? | PremiumBandDescription |
| Text? | CommissionOptionDescription |
| List< Premium> | Premiums |
| Sequence | Sequence |
| PremiumStatus | PremiumStatus |
| Currency | PremiumAmount |
| Date | DepositDate |
| TaxCharacterizationPremium | TaxCharacterizationPremium |
| Suspense | Suspense |
| EndEntity | |

FIG. 3 depicts a block diagram of hardware that may be used to contain or implement program instructions. A bus 300 serves as an information highway interconnecting the other illustrated components of the hardware. CPU 303 is a processing unit for the system, performing calculations and logic operations required to execute a program. CPU 303, alone or in conjunction with one or more of the other elements disclosed in FIG. 3, is an example of a production device, computing device or processor as such terms are used within this disclosure. Read only memory (ROM) 310 and random access memory (RAM) 315 constitute examples of non-transitory computer-readable storage media.

A controller 320 interfaces with one or more optional non-transitory computer-readable storage media 325 to the system bus 300. These storage media 325 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 310 and/or the RAM 315. Optionally, the program instructions may be stored on a tangible non-transitory computer-readable medium such as a compact disk, a digital disk, flash memory, a memory card, a USB drive, an optical disc storage medium, such as a Blu-ray™ disc, and/or other recording medium.

An optional display interface 330 may permit information from the bus 300 to be displayed on the display 335 in audio, visual, graphic or alphanumeric format. Communication with external devices, such as a printing device, may occur using various communication ports 340. A communication port 340 may be attached to a communications network, such as the Internet or an intranet.

The hardware may also include an interface 345 which allows for receipt of data from input devices such as a keyboard 350 or other input device 355 such as a mouse, a joystick, a touch screen, a remote control, a pointing device, a video input device and/or an audio input device.

Several of the features and functions disclosed above may be combined into different systems or applications, or combinations of systems and applications. Various presently unforeseen or unanticipated alternatives, modifications, variations or improvements therein may be subsequently made by those skilled in the art, each of which is also intended to be encompassed by the following claims.

1. A computer-implemented method of generating a database file, comprising, by a processor:
generating a user interface for receiving database information;
receiving, via the user interface, a plurality of entities and at least one attribute that is associated with each entity;
generating, in an intermediate language, one or more database files that comprise:
one or more relationships for each entity,
one or more rules that define how a result will be sent to a database in response to a query, and
one or more rules that define how a result will be retrieved from a database in response to a query; and
applying the database files to a database library to generate a database comprising the entities, the relationships and the rules.

2. The method of claim 1, wherein each of the relationships in each entity's database file comprises at least one of the following:
an attribute that is associated with the entity; or
another entity with which the entity is associated.

3. The method of claim 1, further comprising;
generating one or more entity files in the intermediate language, wherein each entity file contains attributes for one or more of the selected entities so that each selected entity and its attributes are represented in the entity files;
receiving a process model via the user interface; and
generating a process file in the intermediate language for the process model.

4. The method of claim 3, wherein, for each entity, receiving the entity and generating the associated entity file comprises:
receiving a name for the entity;
receiving a type for each received attribute for the entity; and
saving the name, attributes and types in the entity file according to a intermediate language entity file structure.

5. The method of claim 2, wherein, for each database file whose entity is associated with another entity, the method also comprises:
identifying the other entity;
determining a relationship identifier; and
saving a name of the entity, a name of the other entity, and the relationship identifier in the database file according to a pre-defined intermediate language process file structure.

6. The method of claim 3, further comprising:
presenting the user interface so that the user interface comprises:
an entity definition module, and
a process modeling module comprising a plurality of graphic representations of actions and a layout;
wherein receiving the process model comprises receiving a graphic representation of the process model in a flow diagram format.

7. The method of claim 1, wherein generating the database also comprises including, in the database application, a plurality of predefined code portions that do not define any of the entities.

8. A computer-implemented method of generating a database file, comprising, by a processor:
generating a user interface for receiving database information;
receiving, via the user interface, a plurality of entities and at least one attribute that is associated with each entity;
generating, in an intermediate language, one or more database files that comprise:
one or more relationships for each entity, wherein each relationship comprises an attribute that is associated with the entity, or another entity with which the entity is associated,
one or more rules that define how a result will be sent to a database in response to a query, and
one or more rules that define how a result will be retrieved from a database in response to a query;
for each database file whose entity is associated with another entity:
identifying the other entity;
determining a relationship identifier;
saving a name of the entity, a name of the other entity, and the relationship identifier in the database file according to a pre-defined intermediate language process file structure; and
applying the database files to a database library to generate a database comprising the entities, the relationships and the rules.

9. The method of claim 8, further comprising;
generating one or more entity files in the intermediate language, wherein each entity file contains attributes for one or more of the selected entity so that each selected entity's and its attributes are represented in the entity files;
receiving a process model via the user interface; and
generating a process file in the intermediate language for the process model.

10. The method of claim 9, wherein, for each entity, receiving the entity and generating the associated entity file comprises:
receiving a name for the entity;
receiving a type for each received attribute for the entity; and
saving the name, attributes and types in the entity file according to a pre-defined intermediate language entity file structure.

11. The method of claim 8, further comprising:
presenting the user interface so that the user interface comprises:
an entity definition module, and
a process modeling module comprising a plurality of graphic representations of actions and a layout;
wherein receiving the process model comprises receiving a graphic representation of the process model in a flow diagram format.

12. The method of claim 8, wherein generating the database also comprises including, in the database application, a plurality of predefined code portions that do not define any of the entities.

13. A database file generation system, comprising:
a processor; and
a non-transitory, computer-readable medium containing programming instructions that are configured to instruct the processor to:
generate a user interface for receiving database information;
receive, via the user interface, a plurality of entities and at least one attribute that is associated with each entity;
generate, in an intermediate language, one or more database files that comprise:
one or more relationships for each entity,
one or more rules that define how a result will be sent to a database in response to a query, and
one or more rules that define how a result will be retrieved from a database in response to a query; and
apply the database files to a database library to generate a database comprising the entities, the relationships and the rules.

14. The system of claim 13, wherein each of the relationships in each entity's database file comprises at least one of the following:
an attribute that is associated with the entity; or
another entity with which the entity is associated.

15. The system of claim 13, further comprising additional instructions that are configured to instruct the processor to:
generate one or more entity files in the intermediate language, wherein each entity file contains attributes for one or more of the selected entities so that each selected entity and its attributes are represented in the entity files;
receive a process model via the user interface; and
generate a process file in the intermediate language for the process model.

16. The system of claim 15, wherein, for each entity, the instructions to receive each entity and generate the associated entity file comprise instructions to:
receive a name for the entity;
receive a type for each received attribute for the entity; and
save the name, attributes and types in the entity file according to an intermediate language entity file structure.

17. The system of claim 14 further comprising additional instructions to, for each database file whose entity is associated with another entity:
identify the other entity;
determine a relationship identifier; and
save a name of the entity, a name of the other entity, and the relationship identifier in the database file according to a pre-defined intermediate language process file structure.

18. The system of claim 15, further comprising additional instructions to:
present the user interface so that the user interface comprises:
an entity definition module, and
a process modeling module comprising a plurality of graphic representations of actions and a layout;
wherein the instructions to receive the process model comprise instructions to receive a graphic representation of the process model in a flow diagram format.

19. The system of claim 13, wherein the instructions to generate the database also comprise instructions to include, in the database application, a plurality of predefined code portions that do not define any of the entities.
